(19) United States
(12) Patent Application Publication
(10) Pub. No.: US 2007/0180101 A1
(43) Pub. Date: Aug. 2, 2007

(54) System and method for storing data-network activity information

(75) Inventors: Lee Chen, Saratoga, CA (US); Rishi Sampat, Santa Clara, CA (US); John Chiong, San Jose, CA (US); Dennis I. Oshiba, Fremont, CA (US)

Correspondence Address: KAPLAN GILMAN GIBSON & DERNIER L.L.P., 900 ROUTE 9 NORTH, WOODBRIDGE, NJ, 07095, US

(73) Assignee: A10 Networks Inc.

(21) Appl. No.: 11/328,823

(22) Filed: Jan. 10, 2006

(51) Int. Cl. G06F 17/00; G06F 15/173

(52) U.S. Cl. 709/224; 707/100

(57) ABSTRACT

A system and method are disclosed that may include receiving a first event log for a data network user; identifying the user that is the subject of the first event log; updating a user activity record, within stored user activity records, with activity information included in the first event log, the activity information being represented in a first format in the first event log; and repeating the steps of receiving, identifying, and updating for at least one additional event log having activity information stored therein in at least one format other than the first format.

### BACKGROUND OF THE INVENTION

This invention relates generally to data networking, and more specifically, to a system and method of analyzing and correlating identity information with event logs using different formats.

Companies today rely heavily on the proper functioning of their data networks. Critical business activities and operations are conducted over the company data network. It is important that the company data network be secure. Typically there are many users, from different business divisions, and different locations, conducting different business activities over the company data network. To ensure security, a company typically deploys a plurality of firewalls to guard and to guide usage of the network. It is common that a company deploys many different types of firewalls. In one example, a HTTP proxy firewall is deployed to secure Internet access; a network address translation (NAT) firewall is deployed to provide private IP addresses; an intrusion detection network device is deployed to detect network intrusion from outside of the network; and a load balancer is deployed to provide high availability for company web services to its customers.

To ensure proper functioning and security of the network, it is beneficial to analyze information reported by the firewalls. The analysis is usually conducted either in real time or in scheduled time (i.e. according to schedule). Such analysis is done by collecting event logs from firewall and by correlating the event logs together.

Different firewalls encode event logs using different formats, such as WELF, PIX (Private Internet Exchange) format, or LEA format. Typically an equipment vendor supports only a few formats that are used in the vendor's product. For example, Cisco supports PIX format and IOS format. However, for example, Cisco does not support LEA format. An equipment vendor generally provides tools to analyze event logs from the vendor's products.

When a company deploys multiple firewalls from different vendors using different formats, the company cannot analyze the event logs of the firewalls using any single vendor's analysis tool. Firewall consumers generally only deploy firewalls using formats that are supported by a single vendor.

Therefore, there is a need in the art for an improved system and method for organizing event logs.

### SUMMARY OF THE INVENTION

According to one aspect, the present invention may include a method that may include receiving a first event log for a data network user; identifying the user that is the subject of the first event log; updating a user activity record, within stored user activity records, with activity information included in the first event log, the activity information being represented in a first format in the first event log; and repeating the steps of receiving, identifying, and updating for at least one additional event log having activity information stored therein in at least one format other than the first format.

According to another aspect, the invention may include an apparatus that may include a computing system having at least one processor, wherein the computing system is operable to: receive a first event log for a data network user; identify the user that is the subject of the first event log; update a user activity record, in stored user activity records, with activity information included in the first event log, the activity information being represented in a first format in the first event log; and repeat the steps of receiving, identifying, and updating for at least one additional event log having activity information stored therein in at least one format other than the first format.

Other aspects, features, advantages, etc. will become apparent to one skilled in the art when the description of the preferred embodiments of the invention herein is taken in conjunction with the accompanying drawings.

### BRIEF DESCRIPTION OF THE DRAWINGS

For the purposes of illustrating the various aspects of the invention, there are shown in the drawings forms that are presently preferred, it being understood, however, that the invention is not limited to the precise arrangements and instrumentalities shown.

FIG. 1 is a block diagram of a secure data network in accordance with one or more embodiments of the present invention;

FIG. 2 is a block diagram of a system and method for generating a user identity record for a user of the secure data network of FIG. 1 in accordance with one or more embodiments of the present invention;

FIG. 3 is a block diagram of a system and method for analyzing an event log in accordance with one or more embodiments of the present invention;

FIG. 4 is a list of event logs in different formats in which each event log may include an IP address, in accordance with one or more embodiments of the present invention;

FIG. 5 is a block diagram of a log analyzer coupled to a plurality of network gateways in accordance with one or more embodiments of the present invention; and

FIG. 6 is a block diagram of a process for analyzing event logs encoded in different formats from a plurality of network gateways in accordance with one or more embodiments of the present invention.

### DETAILED DESCRIPTION OF THE PREFERRED EMBODIMENTS

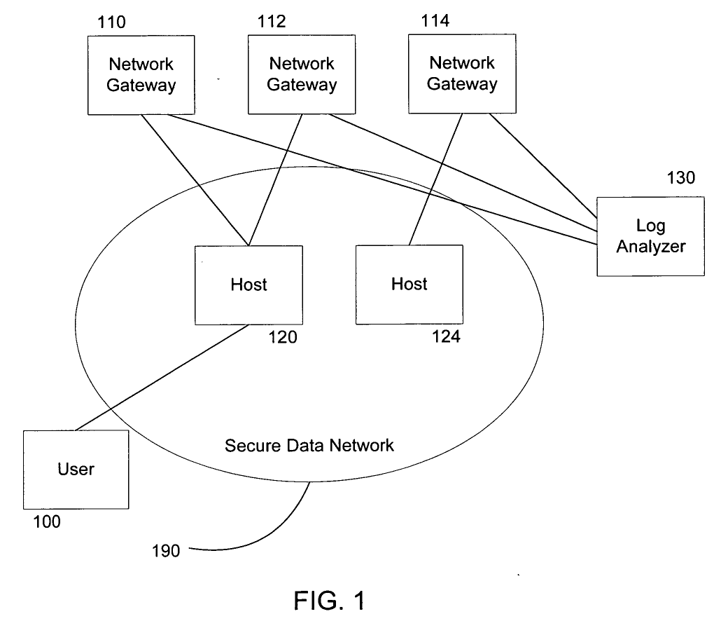

FIG. 1 illustrates a secure data network 190 in accordance with one or more embodiments of the present invention. Secure data network 190 may include a plurality of network gateways 110, 112 and 114. Network gateways 110, 112 and 114 may connect to Log analyzer 130. Log analyzer 130 may be implemented using a server blade. Data network 190 may also include user 100, a plurality of hosts 120 and 124 and log analyzer 130.

User 100 (and other “users” identified with different reference numerals herein) and hosts 120 and 124 (and other “hosts” identified using other reference numerals herein) may be implemented using personal computers or other computing systems known in the art.

In one or more embodiments, network gateways 110, 112 and 114 may process data traffic or data packets leaving secure data network 190 or entering secure data network 190.

In one or more embodiments, a network gateway is at a border of secure data network 190. A network gateway may be a router, an edge router, a border router, a border gateway, a broadband gateway, a firewall, a wireless access point, a wireless access router, a session border controller, or a network device where network traffic is aggregated.

In one or more embodiments, a network gateway may translate data traffic flowing between secure data network 190 and data transmission and/or reception equipment located in communication with secure data network 190.

In one or more embodiments, the translation may include network address translation (NAT). In one or more other embodiments, the translation may include a session proxy such as HTTP proxy, or SIP proxy. This translation may include translating information in the network layer, the transport layer, and/or the application layer.

In one or more other embodiments, the translation may include an application proxy such as web server load balancer, or another application-based load balancer. Where a load balancer is employed, the data format of the information before and after the translation may be the same.

In one or more embodiments, a plurality of hosts or host computers 120, 124 may access secure data network 190. In one embodiment, network gateways 110, 112 and 114 may process data traffic going to or coming from hosts 120 and 124.

In one or more embodiments, a user 100 may use host 120 to access secure data network 190. In one embodiment, secure data network 190 may include a data network based on Internet Protocol (IP). In one embodiment, secure data network 190 may include one or more wireless local area networks (WLAN), the use of Ethernet protocol, one or more wide area networks (WAN), one or more virtual private networks (VPN). In one embodiment, secure data network 190 may include a public data network type such as a WiFi (Wireless Fidelity) network, a hotspot network, or a cellular network.

In one or more embodiments, log analyzer 130 may collect event logs from network gateways 110, 112 and 114. The event logs may relate to hosts 120, 124. Log analyzer 130 may filter the event logs related to hosts 120 or 124 used by user 100. Log analyzer 130 may then process the filtered event logs by correlating information about user 100.

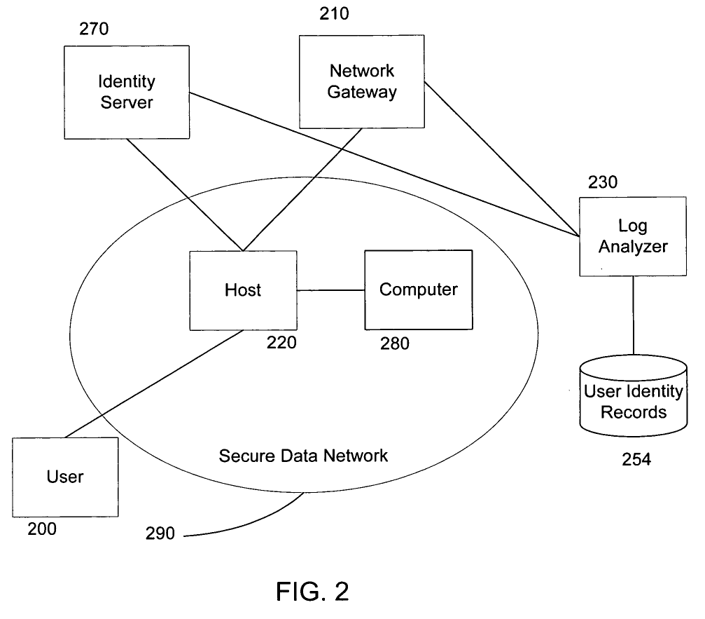

FIG. 2 is a block diagram of a system and method for generating a user identity record for a user of the secure data network of FIG. 1 in accordance with one or more embodiments of the present invention. A user 200 may use a host 220 to access a secure data network 290.

In one or more embodiments, host 220 may request that user 200 log into secure data network 290. Host 220 may then connect to identity server 270 for identity processing. In one embodiment, host 220 may be connected to identity server 270 through a network or a plurality of networks. In another embodiment, host 220 may connect to identity server 270 through an application programming interface, a function call, and/or a remote procedure call. Identity server 270 may be a remote access server, or a virtual private network server.

In one or more embodiments, user 200 may provide user information to host 220, such as, for instance, a user name and/or a password. Host 220 may then send the user information to identity server 270. Identity server 270 preferably identifies user 200 based on the provided user information.

In one embodiment, identity server 270 may authenticate user 200 based on the user information. In another embodiment, identity server 270 may automatically accept user 200. Identity server 270 may then send a notification to host 220 indicating identification of user 200. Upon receiving the notification, host 220 may allow user 200 to access secure data network 290. User 200 may use host 220 to access secure data network 290.

Identification Using Host Information:

In one or more other embodiments, host 220 may provide host information, including information such as a MAC address, a host name, or other information related to identity of host 220 to identify server 270. In one embodiment, the host information may include user information. Additionally or alternatively, Host information may include network identity. In another embodiment, network analyzer 230 may determine network identity.

Identity server 270 may identify host 220 based on the host information. If identity server 270 successfully identifies the identity of host 220, it may send a notification to host 220 indicating the identification of host 220. Host 220 may then allow user 200 to access secure data network 290. User 200 preferably uses host 220 to access secure data network 290.

User Information Contents

In one or more embodiments, the user information may include a user identity identifying user 200. A user identity may include a user's name, a network domain name, a department name, a name of a business unit, a name of an organization, a company name, an identification of a particular computer, and/or an identifying string of characters that is not descriptive of any of the foregoing entities.

In one or more alternative embodiments, identity server 270 may determine a user identity by querying a computer in secure data network 290, which computer may be host 220, or other computer 280.

Identification of Network Identity of Host Computer:

Identity server 270 may determine a network identity of host 220. The network identity may be a host name, an IP address, an Ethernet MAC address, a WiFi MAC address, a port or interface identity, a virtual circuit identity, or a slot number. Host 220 may provide its network identity to identity server 270. Alternatively, identity server 270 may determine the network identity of host 220 by querying computer 280 in secure data network 290.

Provision of Identity Information to Log Analyzer:

In one or more embodiments, log analyzer 230 may be connected to identity server 270 and may employ such connection to obtain identity information from identity server 270. This “identity information” may include a user identity of user 200 and a network identity of host 220.

In one embodiment, identity server 270 may provide identity information to log analyzer 230 during or after the identification of user 200 or host 220. Alternatively, identity server 270 may provide identity information to log analyzer 230 periodically, at scheduled times after identifying user 200 or host 220. The described provision of identity information to log analyzer 230 may occur immediately after or a significant period of time after the identification of user 200 or host 220. The time period in between identification of user 200 and the provision of identity information to log analyzer 230 may be any of the following: 200 milliseconds, 10 seconds, 25 seconds.

In one embodiment, log analyzer 230 requests identity server 270 for identity information by sending an identity information request to identity server 270. The identity information request may include information about user 200 and/or about host 220. This information about user 200 or host 220 may, for instance, include information that identifies a category or classification of users or hosts without necessarily specifying a particular user or host.

Alternatively, the identify information request from log analyzer 230 may request identity information without including such information about any user or host.

Scheduling of Transmission of Identity Information Request:

This identity information request may be sent periodically, or at a scheduled time. In another embodiment, log analyzer 230 may send an identity information request to identity server 270 after receiving an indication from network gateway 210. An indication may include an event log. Alternatively, an indication may include information that gives notice of the first observed traffic from a host computer.

In one embodiment, log analyzer 230 may include, or be placed in communication with, a datastore of user identity records 254. In this specification, a “datastore” may include one or more of the items from a group that includes but is not limited to: a computer memory, a hard-disk, a database, a flash memory, a programming logic that stores data, and a storage device. A user identity record may include a user identity of user 200 and a network identity of host 220, where user 200 uses host 220 to access secure data network 290. Alternatively, the datastore that stores user identity records 254 may be housed separately from log analyzer 230 and be in communication with log analyzer 230. Log analyzer 230 may accumulate identity information to provide user identity records 254.

Alternatively, a network administrator or a network engineer may create a user identity record in user identity records 254.

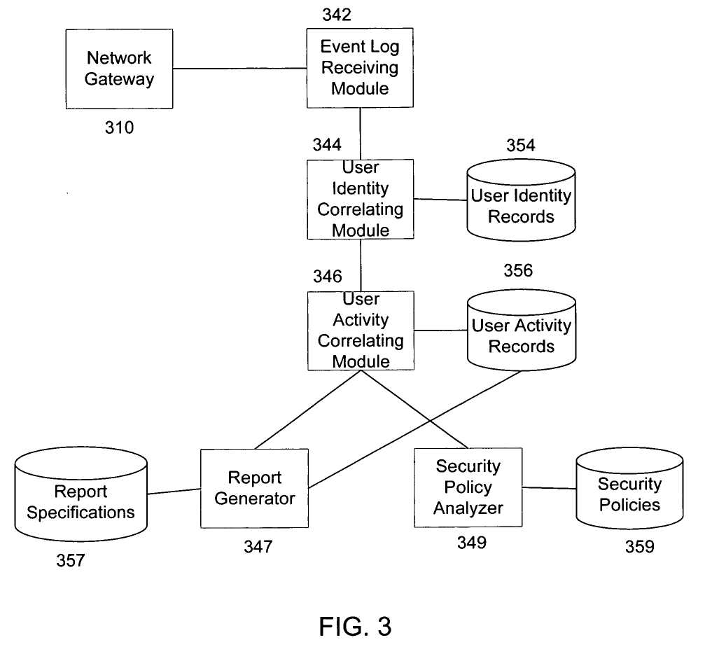

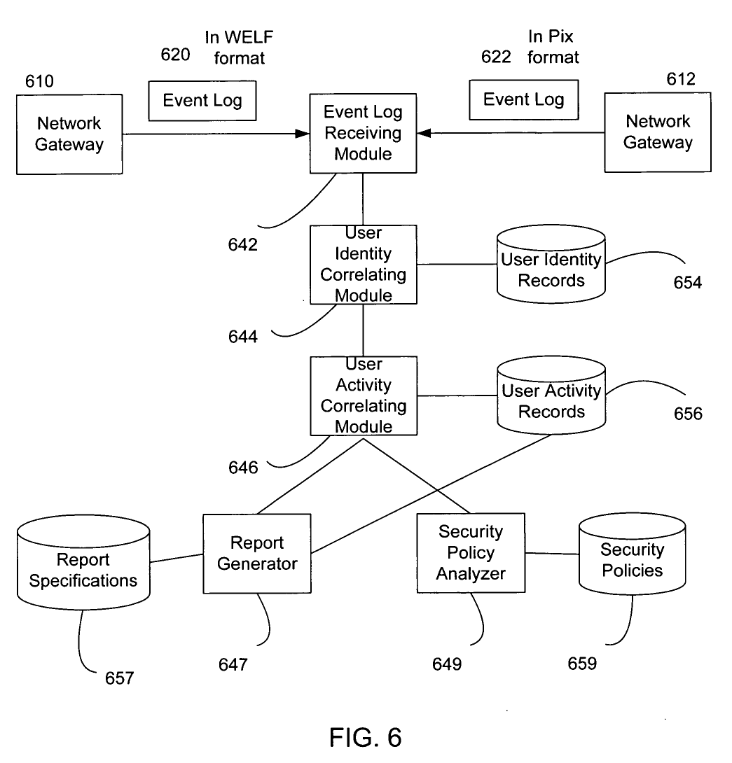

FIG. 3 is a block diagram of a system and method for analyzing an event log in accordance with one or more embodiments of the present invention. The system of FIG. 3 may include network gateway 310. The system of FIG. 3 may also include event log receiving module 342, user identity correlating module 344, user activity correlating module, 346, report generator 347, each of which may be implemented by one of skill in the art using known and commercially available software, hardware, or a combination of the two. Similarly, the similarly named functional blocks, even though identified with different reference numerals, discussed in connection in FIG. 6 of this application may also be implemented using software and/or hardware that is known in the art.

The system of FIG. 3 may also include security policy analyzer 349, user identity records 354, user activity records 356, security policies 359, and report specifications 357, each of which may be implemented using a datastore, the implementation of which is described elsewhere herein. The similarly named, although differently numbered, blocks of FIG. 6 of this application may also be implemented using a datastore.

Log analyzer 230 may receive and process an event log from a network gateway 310. This process may include one or more steps processed by event log receiving module 342, user identity correlating module 344, user activity correlating module 346, report generator 347, and/or security policy analyzer 349.

Event log receiving module 342 may receive an event log from network gateway 310. Such event logs may be encoded in one or more of the following formats: WebTrends Enhanced Log Format (WELF), Cisco PIX format (PIX), CheckPoint and Log Export API (LEA). API stands for Application programming Interface. LEA is part of OPSEC (Open Platform for Security Enterprise Connectivity) by Checkpoint software Technologies Ltd. (http://www.checkpoint.com).

Event log receiving module 342 may establish a communication session with network gateway 310. Event log receiving module 342 may automatically receive an event log from network gateway 310. In another embodiment, event log receiving module 342 may send a request for an event log to network gateway 310 and thereafter receive the requested event log therefrom. In yet another embodiment, event log receiving module 342 may receive a request from network gateway 310 to receive event log from network gateway 310.

Event log receiving module 342 may send the above-described request at a scheduled time, periodically or when another condition is met. In one embodiment, event log receiving module 342 receives the event log from network gateway 310 within a short time after network gateway 310 generates the event log. Network gateway 310 may provide an event log immediately after generating the event log. Network gateway 310 may provide an event log less than 100 milliseconds after generating the event log. Network gateway 310 may provide an event log less than 5 seconds after generating the event log.

User identity correlating module 344 may correlate the received event log with a user identity. In one embodiment, user identity correlating module 344 may connect to a datastore containing user identity records 354. User identity correlating module 344 may correlate the received event log with a user identity based on user identity records 354. In one embodiment, an event log may include a network identity, which may in turn include a host name and/or an IP address.

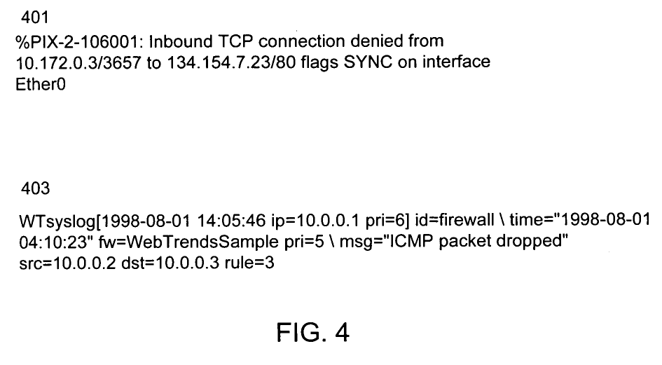

FIG. 4 illustrates several exemplary event logs in different formats where each event log may include an IP address. Event log 401 is in PIX format and lists a source IP address 10.172.0.2 and a destination IP address 134.154.7.23. Event log 403 is in WELF format and lists a source IP address 10.0.0.2 and a destination IP address 10.0.0.3.

User identity correlating module 344 may extract a network identity from the received event log. User identity correlating module 344 may then match the extracted network identity against user identity records 354. Where there is a matching user identity record, user identity correlating module 344 may extract the user identity from the matched user identity record. User identity correlating module 344 may then correlate the received event log with the extracted user identity.

Where there is no matching stored user identity record in user identity records 354, user identity correlating module 344 may correlate the received event log with the extracted network identity. In such situations, the network identity rather than the user identity may be used to identify the pertinent user activity record in stored user activity records 356. Upon successfully completing this identification, the pertinent user activity record, within stored user activity records 356, may be updated using information from the received event log.

User activity correlating module 346 may process received event log with related user activity records. User activity correlating module 346 may connect to a datastore containing a plurality of user activity records 356. User activity correlating module 346 may then match the extracted user identity against user activity records 356, and obtain a matching user activity record. User activity correlating module 346 may then update the matching user activity record with information in the received event log.

The matching user activity record and the received event log may include a) data traffic information, b) web site information, c) communication session information, 4) data traffic violation information, and/or e) protocol information. For each of the listed types of information which may form part of the user activity record and/or the received event log, user-activity correlating module 346 preferably suitably updates the corresponding entry in the matching user activity record with information in the received event log.

Data traffic information may include a data traffic measurement, data traffic statistics, data traffic statistics per protocol, bandwidth information, and/or bandwidth utilization.

Web site information may include web site identity, web site access method, and/or web site statistics. Web site identity may include an URL, a web server name, a web document name, a web query, or an IP address. Web site access method information may include a protocol such as HTTP or HTTPS, a protocol command such as GET or POST, a web page formatting language such as HTML or XML. Web site statistics information may include a number of web sites visited, a number of visits to a web site with the same web site identity, a number of failed attempts to a web site, and/or an amount of data traffic to a web site.

In one embodiment, communication session connection information may include session set-up, session disconnect, and/or session denial information. In another embodiment, communication session connection information may include TCP connection information, HTTP connection information, and/or other protocol connection information.

Data traffic violation information may include communication session connection denial information, computer virus, prohibited destination network address information, unreachable destination network address information, and/or any user-defined security violation condition.

The protocol information may include a protocol identity, a protocol state, protocol statistics such as number of sessions, and/or data traffic using the protocol.

In one or more embodiments, security policy analyzer 349 may analyze an updated user activity record to determine if a security policy has been violated. A security policy may include a security condition and/or a security alert. Security policy analyzer 349 may determine whether the security condition of a security policy is satisfied, using the updated user activity record.

If the condition is satisfied, the updated user activity record violates the security policy. Security policy analyzer 349 preferably generates an alert based on the security alert in the security policy. The generated alert may include information about the extracted user identity, extracted network identity, the security policy, and/or the update user activity record.

In one embodiment, a security condition may relate to protocol usage. For example, the security condition may be a number of TCP connections exceeding a threshold, for example, 100 per second. In another embodiment, a security condition may be an amount of bandwidth used by which file transfer protocol FTP activity exceeds a threshold, for example, 100 MB over 10 second interval.

In another embodiment, a security condition may relate to Internet usage. For example, a security condition may be a number of web sites visited in excess of a threshold, for example 1000 over 3 second interval. In another scenario, a security condition may be “web site visited is yahoo.com”, or “web site visited is prohibited, based on a list of pre-stored web sites”. In another example, a security condition may be “web page accessed is a streaming video.”

In yet another embodiment, a security condition may relate to bandwidth utilization, an application such as instant messaging, or a destination network identity such as a certain computer or network.

In one or more embodiments, security policy analyzer 349 may connect to a datastore including a plurality of security policies 359. Security policy analyzer 349 may apply security policies 359 to the updated user activity record.

Security policy analyzer 349 may process security policies 359 relating to entities including but not limited to one or more of the following: the extracted user identity, the extracted network identity, the current time.

Report generator 347 may generate reports relating to one or more user activity records 356. Report generator 347 may process an updated user activity record to generate a report. The generated report may be presented on a computer console, or may be sent to another computer.

In one embodiment, report generator 347 may process an updated user activity record immediately after user-activity correlating module 346 completes the update. Alternatively, report generator 347 may process the updated user-activity record at a scheduled time after user-activity correlating module 346 completes the update.

Report generator 347 may connect to a datastore including a plurality of report specifications 357. Report generator 347 may generate a report based on a report specification.

In one embodiment, a report specification may relate to corporate policies, or government regulations. In one scenario, corporate policies may include authentication information, access to a list of computers, a list of business software applications, and/or bandwidth utilization. Government regulations may include access to corporate confidential financial documents and/or the network activities of a user.

In one embodiment, a report specification is not limited to, but may include one or more of, the following: an analysis for generating a report, a query to a relational database, a table filtered based on a plurality of fields in the table, a merge operation on a plurality of tables, and a ranking operation.

In another embodiment, a report specification is not limited to, but may include, one or more of the following: a format of a report, a method to publish a report, and timing information. The timing information may include a scheduled time to generate a report, such as 5 pm on Jul. 26, 2005, report generation that may occur periodically, such as, daily at 6 am, or every hour during business days.

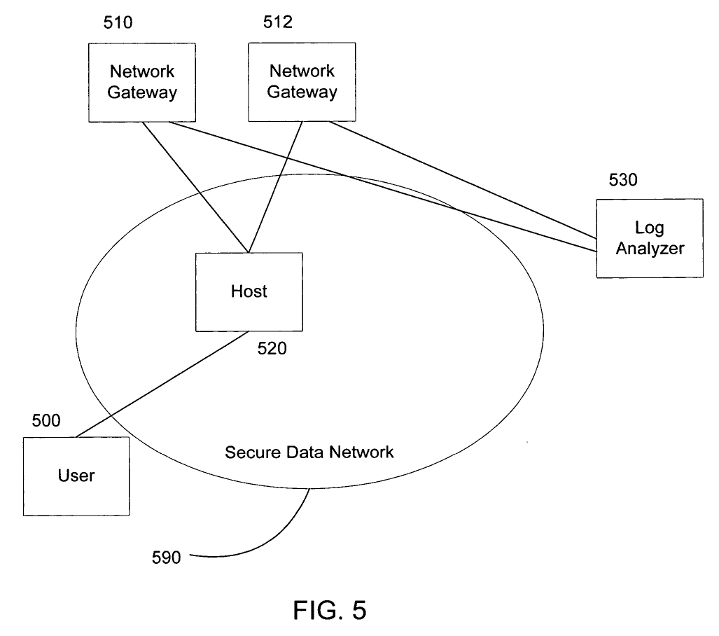

FIG. 5 illustrates a log analyzer connecting to a plurality of network gateways. Log analyzer 530 may connect to a first network gateway 510 and a second network gateway 512. Network gateway 510 may encode event logs in a first format, while network gateway 512 may encode event logs in a second format. Preferably, the first format is different from the second format. In one embodiment, the first format may be the WELF format, and the second format may be the PIX format. In another embodiment, the first format is the LEA format. Log Analyzer 530 may analyze event logs encoded in the different formats.

FIG. 6 illustrates a process of analyzing event logs encoded in different formats from a plurality of network gateways.

Log Analyzer 530 may receive and process event logs from network gateways 610 and 612. Preferably, event logs from network gateway 610 are encoded in a first format, and event logs from network gateway 612 are encoded in a second format. The first format is preferably different from the second format. In one embodiment, event logs from network gateway 610 are encoded in WELF format, and event logs from network gateway 612 are encoded in a PIX format.

Event log receiving module 642 may receive event log 620 encoded in WELF format from network gateway 610 and may receive event log 622 encoded in PIX format from network gateway 612. Event log receiving module 642 may receives event logs 620 and 622 as described in connection with FIG. 3.

User identity correlating module 644 preferably extracts a network identity from event log 620 encoded in WELF format. User identity correlating module 644 may then compare the extracted network identity with user identity records 654, and extract a first user identity from a matching user identity record. The first user identity preferably correlates to event log 620.

User identity correlating module 644 preferably extracts a network identity from event log 622 encoded in PIX format. User identity correlating module 644 may then compare the extracted network identity with user identity records 654, and extract a second user identity from a matching user identity record. The second user identity correlates to event log 622.

In one or more embodiments, user activity correlating module 646 preferably compares the first user identity to user activity records 656, and preferably obtains a first matching user activity record. User activity correlating module 646 may then update the first matching user activity record with information in event log 620 encoded in WELF format as described in connection with FIG. 3. User activity correlating module 646 may then compare the second user identity to user activity records 656, and obtain a second matching user activity record. User activity correlating module 646 may then update the second matching user activity record with information in event log 622 encoded in PIX format as described in connection with FIG. 3.

In one embodiment, the first user identity is generally different from the second user identity. The first matching user activity record and the second matching user activity record are preferably two different user activity records. After the update, the first matching user activity record preferably includes information from event log 620, and the second matching user activity record preferably includes information from event log 622.

In another embodiment, the first user identity is the same as the second user identity. In this embodiment, the first matching user activity record and the second matching user activity record are preferably the same. In this embodiment, after the update, the same user activity record preferably includes information from both event log 620 and event log 622, which may have originated from network gateways 610 and 620, respectively.

Security policy analyzer 649 may process the updated user activity records, and may generate a security alert according to the process described in connection with FIG. 3.

Report generator 647 may process the updated user activity record or updated user activity records, and may generate reports according to the process in FIG. 3.

Preferred embodiments of the instant invention may operate on a network, such as, for example, the Internet, or another type of remote access system, such as a kiosk-based terminal, a telephone, a personal digital assistant, a pulse code system, web TV, or any other device or method that communicates alpha numeric data through a server.

Preferred embodiments of the instant invention may operate in accordance with a plurality of networked computers, such as, for example, a user computer and a server computer which are coupled together on a communications network, such as, for example, the Internet or a wide area network. Network communication hardware that operates to implement preferred embodiments of the invention may include a server computer and a client computer terminal, wherein the server computer and the user computer are in electronic communication with each other via a network. The network may be a local area network (LAN), a wide area network (WAN), or the Internet, and may be hardwired, wireless, or a hybrid thereof.

In some preferred embodiments, the network communication hardware may include a plurality of either servers, client computers, or any combination thereof. The server may incorporate a memory device from which information and other relevant data is accessible to the client computer. It will be understood that network systems in accordance with various embodiments can include more than two servers.

The server may include any suitable network-connectable device capable of providing content (data representing text, hypertext, photographs, graphics, video and/or audio) for communication over the network. In preferred embodiments, the server computer is a programmable processor capable of operating in accordance with programs stored on one or more computer readable media (for example, but not limited to, floppy disks, hard disks, random access memory RAM, CD-ROM, and ZIP disks), to provide content for communication to the client computer. The server computer may include, for example, but is not limited to, a personal computer, a mainframe computer, a network a computer, a portable computer, a personal digital assistant (PDA, such as, a 3Com Palm Pilot), or the like. The server computer may include one or more internal data storage devices, e.g. a hard drive (not shown), for storing content for communication to the client computer. Alternatively, or in addition, the server computer may be coupled to an external data storage device, computer or other means, from which the server computer may obtain information for communication to the client computer. In one embodiment, the external device may include at least one further network device coupled to the network. The server computer may be controlled by suitable software to provide requested content information to the client computer, provided that various criteria are met.

In a preferred WAN environment, such as the Internet, the server computer may be controlled by software adapted to generate a response to a valid request for content information by transmitting or downloading data in the form of one or more HTML files to a requesting client computer. It will be understood by those skilled in the art that this process involves communication through routers and other network components in addition to suitable servers, as is dictated by the particular network environment.

The client computer may include any suitable network-adapted device capable of communicating with other devices in the network system according to an established protocol. In preferred embodiments, the client computer may include a programmable processor capable of operating in accordance with programs stored on one or more computer readable media (for example, but not limited to a floppy disk, a hard disk, a computer network, a random access memory (RAM), a CD Rom, ZIP disks, or the like). The client computer may also include a display device for providing a user-perceivable display (for example, but not limited to visual displays, such as cathode ray tube (CRT) displays, light-emitting-diode (LED) or liquid-crystal-diode (LCD) displays, plasma displays or the like, audio displays or tactile displays), and a user input device (for example, but not limited to, a keyboard, mouse, trackball, touch pad, microphone, or the like). In one preferred embodiment, the client computer may include a personal computer system having a CRT display, a keyboard, and a mouse user-input device.

The client computer may be controlled by suitable software, including network communication and browser software to allow a user to request, receive and display information (or content) from or through a the server computer on the network. The client computer may include any means capable of communicating with the server computer(s), including, but not limited to, personal computers, PDAs, email-enabled cell phones, and ATM-type terminals. The client computer may access one or more server computers via the network or through some other remote access, such as, for example, by using conventional telephone lines.

It is noted that the methods and apparatus described thus far and/or described later in this document may be achieved utilizing any of the known technologies, such as standard digital circuitry, analog circuitry, any of the known processors that are operable to execute software and/or firmware programs, programmable digital devices or systems, programmable array logic devices, or any combination of the above. One or more embodiments of the invention may also be embodied in a software program for storage in a suitable storage medium and execution by a processing unit.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method, comprising:
receiving a first event log for a data network user;
identifying the user that is the subject of said first event log;
updating a user activity record, within stored user activity records, with activity information included in said first event log, said activity information being represented in a first format in said first event log; and
repeating said steps of receiving, identifying, and updating for at least one additional event log having activity information stored therein in at least one format other than said first format.

2. The method of claim 1 further comprising:
accumulating activity information in said stored user activity records for said identified user arising from event logs including activity information therein in a plurality of different formats.

3. The method of claim 2 wherein said plurality of different formats includes at least one format selected from the group consisting of:
PIX, webtrends enhanced log format (WELF), and checkpoint log export API (LEA).

4. The method of claim 1 wherein said receiving step is performed at an event log receiving module.

5. The method of claim 4 further comprising:
sending a request to transmit said first event log from a network gateway to said event log receiving module.

6. The method of claim 1 wherein said identifying comprises:
comparing user identity information included in said first event log with user identity information included in stored user identity records using a user identity correlating module.

7. The method of claim 6 wherein said user identity information includes at least one item selected from the group consisting of:
a user's name, a network domain name, a department name, a name of a business unit, a name of an organization, a company name, and an identification of a particular computer.

8. The method of claim 1 wherein said identifying comprises:
comparing network identity information included in said first event log with network identity information included in stored user identity records.

9. The method of claim 8 wherein said network identity information includes at least one item selected from the group consisting of:
a host name, an IP (Internet Protocol) address, an Ethernet MAC address, a Wifi MAC address, port circuitry, interface circuitry, a virtual circuit identity, and a slot number.

10. The method of claim 1 wherein said updating step is performed with a user activity correlating module.

11. The method of claim 1 further comprising:
generating a report relating to one or more of said stored user activity records using a report generator.

12. The method of claim 11 wherein said generating step comprises:
generating said report according to a report specification.

13. The method of claim 1 further comprising:
analyzing at least one of said stored user activity records to determine whether one or more a plurality of security policies have been violated.

14. The method of claim 13 further comprising:
storing said plurality of security policies on a datastore.

15. The method of claim 13 wherein each said security policy includes at least one of:
a security condition; and
a security alert.

16. An apparatus comprising:
a computing system having at least one processor, wherein said computing system is operable to:
receive a first event log for a data network user;
identify the user that is the subject of said first event log;
update a user activity record, in stored user activity records, with activity information included in said first event log, said activity information being represented in a first format in said first event log; and
repeat said steps of receiving, identifying, and updating for at least one additional event log having activity information stored therein in at least one format other than said first format.

17. The apparatus of claim 16 wherein said computing system is further operable to:
accumulate activity information in said stored user activity records for said identified user arising from event logs including activity information therein in a plurality of different formats.

18. The apparatus of claim 17 wherein said plurality of different formats includes at least one format selected from the group consisting of:
PIX, webtrends enhanced log format (WELF), and checkpoint log export API (LEA).

19. The apparatus of claim 16 wherein said computing system is a log analyzer.

20. The apparatus of claim 19 wherein said log analyzer is a server blade.
